(19) United States
(12) Patent Application Publication
(10) Pub. No.: US 2026/0140339 A1
(43) Pub. Date: May 21, 2026

(54) ACTIVE OPTICAL CABLE AND OPTICAL TRANSCEIVER

(71) Applicant: AIP Inc., New Taipei City (TW)

(72) Inventor: Chia Lee, New Taipei City (TW)

(21) Appl. No.: 19/356,139

(22) Filed: Oct. 12, 2025

Related U.S. Application Data
(63) Continuation-in-part of application No. 18/510,668, filed on Nov. 16, 2023.
(60) Provisional application No. 63/528,933, filed on Jul. 26, 2023.
(60) Provisional application No. 63/708,463, filed on Oct. 17, 2024.

(51) Int. Cl. G02B 6/42

(52) U.S. Cl. CPC G02B 6/4292; G02B 6/4246

(57) ABSTRACT

An active optical cable includes a detachable optical cable and an optical transceiver detachably connected to the detachable optical cable. The detachable optical cable includes an optical fiber unit, a boot element disposed around an end portion of the optical fiber unit, a housing structure attached to an end of the boot element and including at least a holding element, and an optical coupling device positioned at the holding element. The optical transceiver includes a casing unit defining an insertion groove for insertion of the detachable optical cable, an optoelectronic substrate disposed in the casing unit, and a waveguide device disposed on the optoelectronic substrate. The optical coupling device is detachably positioned in optical alignment with the waveguide device for light signal transmission between the waveguide device and the optical fiber unit.

### CROSS REFERENCE TO RELATED APPLICATIONS

This application claims the benefit of U.S. provisional patent application Ser. No. 63/708,463, filed Oct. 17, 2024, the entirety of which is incorporated by reference herein.

This application is a continuation-in-part of U.S. patent application Ser. No. 18/510,668 filed Nov. 16, 2023, which claims the priority of U.S. provisional patent application Ser. No. 63/528,933, filed Jul. 26, 2023, the entireties of which are incorporated by reference herein.

### BACKGROUND OF INVENTION

### 1. Field of Invention

The present invention relates to a technical field of optical connectors, and particularly to an active optical cable and an optical transceiver.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and may be co-packaged as co-packaged optics (CPO). Optical communication is commonly used in data centers that are equipped with numerous machines, such as data switches and servers, and each of the switches or servers needs to output data to other devices. Generally, pluggable active optical cable, due to the portability and convenience, are mainly used in data centers for signal transmission with separate devices. However, optical cables and optical transceivers of conventional active optical cables are non-detachable, which makes connecting two switches or servers far apart in the data center time-consuming. If the optical module of the active optical cable is damaged, it cannot be repaired, and the active optical cable must be replaced.

### SUMMARY OF INVENTION

An object of the present application is to provide an active optical cable with a detachable optical cable, and the active optical cable is using optoelectronic integrated circuit or co-package optical device.

Another object of the present application is to provide a detachable optical transceiver with an adapted cable, and the optical transceiver is equipped with an optoelectronic integrated circuit or a co-packaged optical device.

To achieve the above-mentioned objects, in one aspect, the present application provides an active optical cable, including a detachable optical cable and an optical transceiver detachably connected to the detachable optical cable. The detachable optical cable includes: an optical fiber unit; a boot element disposed around an end portion of the optical fiber unit; a housing structure attached to an end of the boot element and including at least a holding element; and an optical coupling device positioned at the holding element, and the end portion of the optical fiber unit extends to the optical coupling device. The optical transceiver includes: a casing unit defining an insertion groove for insertion of the detachable optical cable; an optoelectronic substrate disposed in the casing unit and configured for electrical-to-optical signal conversion and optical-to-electrical signal conversion; and a waveguide device disposed on the optoelectronic substrate. The optical coupling device is positioned in optical alignment with the waveguide device for light signal transmission between the waveguide device and the optical fiber unit.

Optionally, the housing structure further includes at least an engaging element protruding from the housing structure toward the casing unit, and the engaging element abuts against an inner wall of the casing unit in the insertion groove.

Optionally, the casing unit defines at least an engaging groove located corresponding to the engaging element, and the engaging element is positioned in and abuts against the engaging groove.

Optionally, two holding elements are spaced apart from each other, and the optical coupling device is clamped between the two holding elements.

Optionally, the optical coupling device includes a plurality of attaching portions, the waveguide device includes a waveguide base and a plurality of positioning elements arranged on a front end of the waveguide base facing the optical coupling device, and the attaching portions attach to the positioning elements, respectively.

Optionally, a pushing element is disposed in the housing structure, and one end of the pushing element pushes the optical coupling device against the holding elements such that the optical coupling device is tightly held between the holding elements.

Optionally, the waveguide device further includes a waveguide substrate, the waveguide base includes a recessed portion exposed at the front end of the waveguide base, and the waveguide substrate is positioned in the recessed portion configured for optical alignment with the optical coupling device.

Optionally, the detachable optical cable further includes at least a depressible fastening member fixed to the boot element, and the optical transceiver further includes a retaining element mounted to the casing unit, wherein part of the retaining element is located in the insertion groove, and the depressible fastening member snugly abuts the part of the retaining element.

Optionally, the retaining element includes two retaining bars and a base plate connected between the two retaining bars, the retaining bars are symmetrically arranged on opposite ends of the base plate and perpendicular to the base plate, each of the retaining bars includes a first retaining portion bent toward the insertion groove, and the depressible fastening member includes two depressible arms fixed to opposite sides of the boot element, wherein each of the depressible arms includes a fastening hook, which is fastenable with the first retaining portion.

Optionally, each of the retaining bars further includes a second retaining portion protruding toward the insertion groove, and two buffer elements are disposed between the retaining bars and the casing unit, respectively, wherein one end of each of the buffer elements props against the second retaining portion.

Optionally, the insertion groove includes a main groove portion and two slot walls located at opposite sides of the main groove portion, and the depressible arms are located above the slot walls, respectively.

In another aspect, the present application further provides an optical transceiver, adapted to connect to a detachable optical cable, and the optical transceiver includes: a casing unit including a first casing portion and a second casing portion jointly defining an insertion groove for insertion of the detachable optical cable; an optoelectronic substrate disposed on the second casing portion and configured for electrical-to-optical signal conversion and optical-to-electrical signal conversion; a waveguide device detachably disposed on the optoelectronic substrate and including a waveguide base and a waveguide substrate positioned in the waveguide base; and a retaining element mounted to the casing unit. Part of the retaining element is located in the insertion groove for retaining the detachable optical cable, such that a light signal output from the detachable optical cable is transmittable to the waveguide substrate.

In another aspect, the present application further provides an active optical cable including a detachable optical cable and an optical transceiver detachably connected to the detachable optical cable. The detachable optical cable includes an optical fiber unit and an optical coupling device attached to an end of the optical fiber unit. The optical transceiver includes: a casing unit defining an insertion groove for insertion of the detachable optical cable; an optoelectronic substrate disposed in the casing unit and configured for electrical-to-optical signal conversion and optical-to-electrical signal conversion; and a waveguide device including a waveguide base and a waveguide substrate positioned in the waveguide base, and the waveguide base detachably disposed on the optoelectronic substrate, wherein the optical coupling device is positioned in optical alignment with the waveguide substrate for light signal transmission between the waveguide substrate and the optical fiber unit.

Optionally, the waveguide base includes a recessed portion exposed at a front end of the waveguide base, and the waveguide substrate is positioned in the recessed portion of the waveguide base.

Optionally, the waveguide base includes a recessed portion exposed at a front end of the waveguide base, part of an edge of the optoelectronic substrate convexly protrudes into the recessed portion to define the waveguide substrate.

Optionally, the waveguide base includes a plurality of positioning elements, the optical coupling device includes a plurality of attaching portions, and the attaching portions attach to the positioning elements, respectively.

Accordingly, the detachable optical cable can be individually prepared from the optical transceiver that is conducive to improving assembly efficiency by reducing time of reworking in comparison with an unseparated structure of active optical cables or by reducing time of trouble shooting in comparison with optical transceivers without adapted cables assembled, as well as simplifying the maintenance or replacement of internal components of the optical cable.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic perspective view of a detachable optical cable of an active optical cable in accordance with an embodiment of the present application.

FIG. 2 is a schematic perspective view of an optical transceiver of the active optical cable in accordance with an embodiment of the present application.

FIG. 3 is a perspective assembly view of the active optical cable.

FIG. 4 is a schematic perspective view of the active optical cable of FIG. 3 in the absence of a first casing portion.

FIG. 5 is a schematic exploded view of an active optical cable in accordance with an embodiment of the present application.

FIG. 6 is a partially enlarged assembly view of the active optical cable of FIG. 5.

FIG. 7 is a schematic exploded view of the active optical cable of FIG. 3.

FIG. 8 is a schematic perspective view of part of an active optical cable in the absence of a first casing portion and a waveguide device in accordance with an embodiment of the present application.

FIG. 9A is a schematic cross-sectional view of part of an active optical cable in accordance with an embodiment of the present application.

FIG. 9B is a schematic cross-sectional view of part of an active optical cable in accordance with an embodiment of the present application.

FIG. 10 is a schematic structural view showing a plurality of active optical cables detachably connected to a mating module.

FIG. 11 is a schematic view showing a detachable optical cable is adaptable to various types of optical transceiver of the present application.

FIG. 12A is a partially perspective exploded view of an active optical cable in accordance with an embodiment of the present application.

FIG. 12B is a partially perspective exploded view of an active optical cable in accordance with an embodiment of the present application.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

The present application provides an active optical cable and an optical transceiver. In detail, a pluggable optical transceiver with a detachable optical cable constitutes an active optical cable that can be detachably connected to switches in data centers or systems includes co-packaged optics (CPO)-based devices or optoelectronic integrated circuits for optical signal transmission.

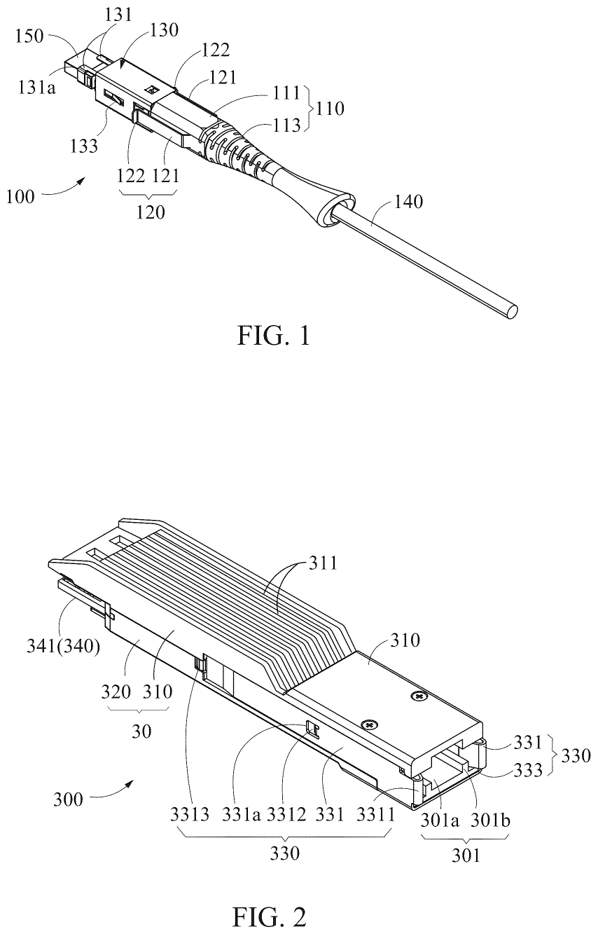

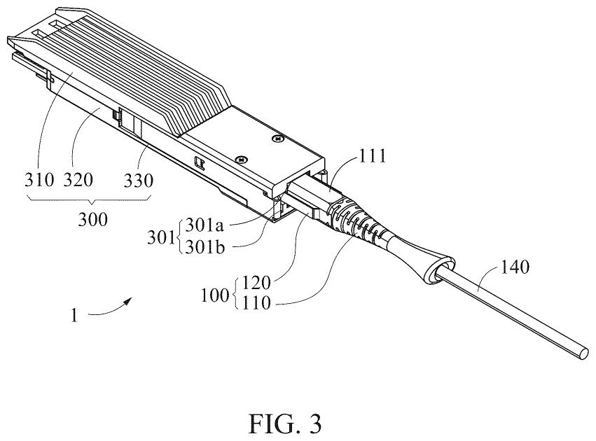

Referring to FIG. 1, which is a schematic perspective view of a detachable optical cable 100 of an active optical cable in accordance with an embodiment of the present application, the detachable optical cable 100 includes a boot element 110, a depressible fastening member 120, a housing structure 130, an optical fiber unit 140, and an optical coupling device 150. The housing structure 130 is attached to an end of the boot element 110 and located between the boot element 110 and the optical coupling device 150. In some embodiments, the housing structure 130 is hollow inside for shielding part of the optical fiber unit 140 and is made of metal material or non-metal material suitable through stamping or molding process. The boot element 110 is configured to be manipulated for ease of the plugging and pulling of the detachable optical cable 100 into and out of an optical transceiver 300 (shown in FIG. 2, described later).

In some embodiments, the boot element 110 includes a boot portion 111 and a transition portion 113. Preferably, the boot portion 111 and the transition portion 113 are integrally formed to improve structural integrity that is endurable for being repeatedly pulling. In detail, one end of the boot portion 111 may encompass part of the housing structure 130 in a way of, for example, insert molding, but is not limited thereto. The transition portion 113 is formed on the other end of the boot portion 111 away from the housing structure 130. In this embodiment, the transition portion 113 is configured to have streamlined features to promote air mobile so that air resistance can be reduced and heat dissipation efficiency of the switch or the system can be improved. In detail, the thickness of the transition portion 113 gradually reduces from opposite ends thereof such that a profile of the transition portion 113 along the entire length thereof is concentrically inwardly curved to form the streamlined features. Preferably, a polymer (antistatic or nano-caulking) coating layer (not shown) is coated on the entire outer surface of the transition portion 113 to reduce air resistance caused by the transition portion 113 when the heat is exhausted from a data process machine such as a switch.

Still referring to FIG. 1, the depressible fastening members 120 is fixed to the boot portion 111. In some embodiments, the depressible fastening member 120 includes a pair of depressible arms 121 symmetrically fixed to opposite sides of the boot portion 111. In this embodiment, the depressible arms 121 are disposed on left and right sides of the boot portion 111. Alternatively, the depressible arms 121 may be arranged on top and bottom sides of the boot portion 111. In detail, each of the depressible arms 121 has a cantilevered structure. In detail, one end of each of the depressible arms 121 is fixed to the boot portion 111 by means of, for example, insert molding. The depressible arms 121 each extend in a direction opposite to the transition portion 113 such that the other end of the depressible arm 121 extends out of the boot portion 111 and is displaceable subject to pressing of the depressible arm 121. In some embodiments, the other end of the depressible arm 121 bent outwardly with respect to the boot portion 111 to form a fastening hook 122. The fastening hook 122 is configured to ensure the fastening connection between the boot element 110 and the optical transceiver 300 after the detachable optical cable 100 is plugged.

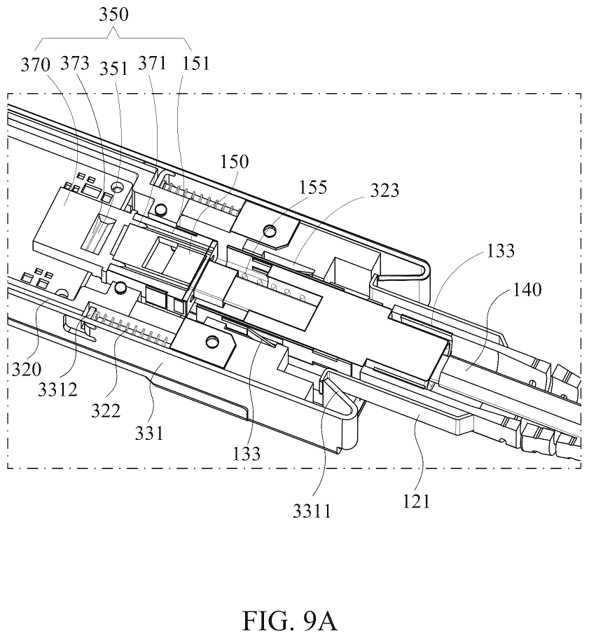

As shown in FIG. 1, the housing structure 130 includes a pair of holding elements 131. In this embodiment, the holding elements 131 are symmetrically arranged on an end of the housing structure 130 adjacent to the optical coupling device 150. In detail, one end of the holding elements 131 is disposed in the housing structure 130, and the other end extends out of the end of the housing structure 130. As shown in FIG. 1, the optical coupling device 150 is detachably positioned at the holding elements 130. In detail, the holding elements 131 are spaced apart from each other and jointly form a holding space between the holding elements 131 so that the optical coupling device 150 is clamped and held by and between the holding elements 130 in the holding space. In some embodiments, the holding element 131 forms a holding through hole 131a. The optical coupling device 150 is being larger at the end thereof than the rest of the optical coupling device 150, so that the large part of the optical coupling device 150 is held in the holding through hole 131a (see FIG. 8 in detail).

Still referring to FIG. 1, the housing structure 130 further includes two engaging elements 133 symmetrically located at the left and right sides of the housing structure 130 and protruding outward from the housing structure 130. In some embodiments, the engaging elements 133 may be integrally formed on the holding elements 131 through a stamping process and pass through side walls of the housing structure 130 to protrude outwardly, or alternately, the engaging elements 133 are formed on the side walls of the housing structure 130.

As shown in FIG. 1, the fastening hooks 122 of the depressible arms 121 are spaced apart from each other and facing left and right sides of the housing structure 130, respectively. The optical coupling device 150 is located at the very front end of the detachable optical cable 100, and the optical fiber unit 140 passes through the transition portion 113 and the boot portion 111 to connect to the optical coupling device 150. In some embodiments, the optical fiber unit 140 may be a multicore optical fiber having two or more cores (not shown) surrounded by a cladding. For example, the optical fiber unit 140 may have four or eight cores arranged in an array. As well understood in the art, each core may convey optical signals independently of the others, so that the multicore optical fiber may function as multiple individual optical fibers and transmit optical signals to the optical transceiver 300 through the optical coupling device 150.

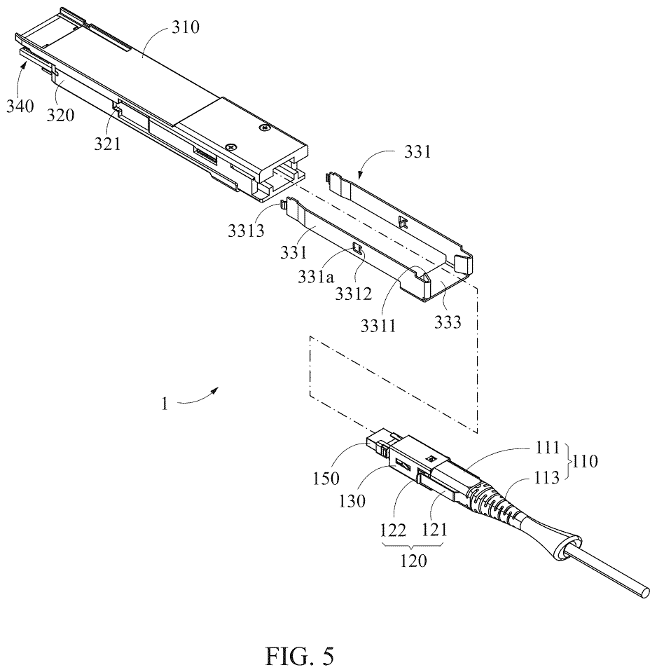

Referring to FIG. 2, FIG. 2 is a schematic perspective view of the optical transceiver 300 of an active optical cable in accordance with an embodiment of the present application. The optical transceiver 300 includes a casing unit 30 mainly consisting of a first casing portion 310 and a second casing portion 320, a retaining element 330, an optoelectronic substrate 340, and a waveguide device 350 (referring to FIG. 4). The first casing portion 310 and the second casing portion 320 are assembled together and collectively form an insertion groove 301 at an end of the optical transceiver 300. In detail, the insertion groove 301 is sized to allow insertion of the housing structure 130 and the boot portion 111 of the detachable optical cable 100. In this embodiment, the insertion groove 301 includes a main groove portion 301a and two slot walls 301b located at left and right sides of the main groove portion 301a. In detail, the main groove portion 301a is sized to fit with the boot portion 111, and each of the slot walls 301b is spaced apart from the first casing portion 310 in a thickness direction to form a sub-groove portion, which is sized to fit with the depressible arms 121.

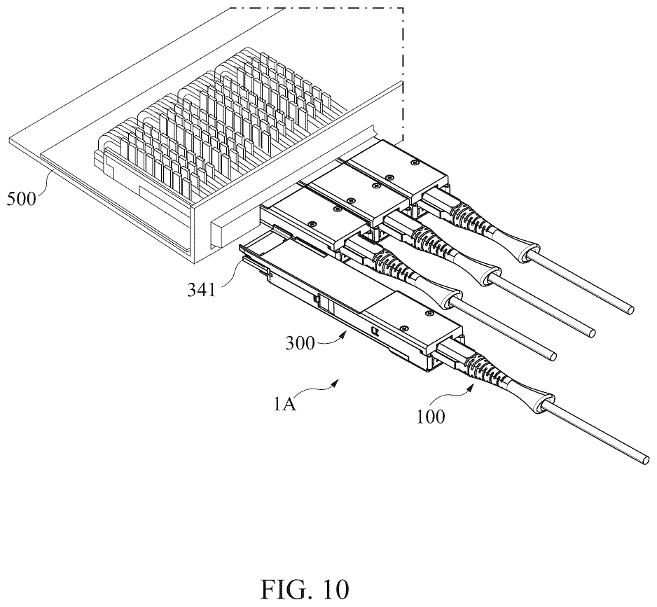

As shown in FIG. 2, one end of the optoelectronic substrate 340 includes a connection portion 341 to be electrically connected to a mating module 500 (as shown in FIG. 10, described later). In some embodiments, the optoelectronic substrate 340 may be equipped with multiple chips including electronic integrated circuits and photonic integrated circuits that may be co-packaged as co-packaged optics (CPO). In detail, the optoelectronic substrate 340 is configured to convert electrical signals to optical signals, or to convert optical signals to electrical signals, so that electrical signals can be transmitted between the connection portion 341 and an applied data process device (not shown), and optical signals can be transmitted between the optical fiber unit 140 and the waveguide device 350.

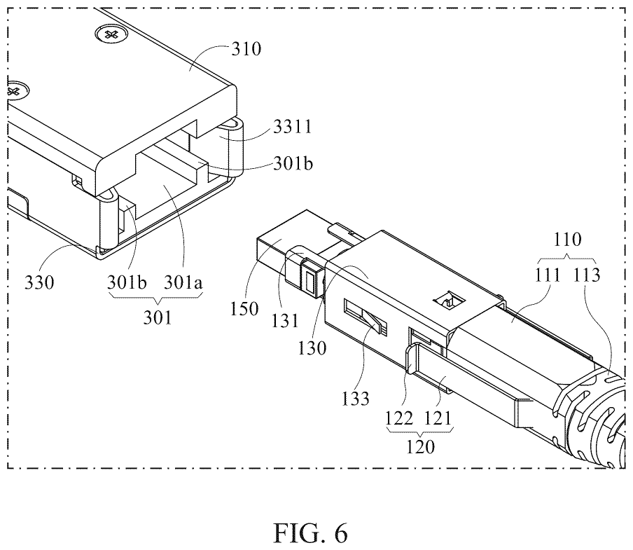

Still referring to FIG. 2, the first casing portion 310 may be structured with a heat sink 311 on a top of the first casing portion 310. The second casing portion 320 is substantially U-like in shape and includes a retaining hole 321 (referring to FIG. 5). The retaining element 330 is mounted to the casing unit 30 (referring to FIG. 5), and part of the retaining element 330 is located in the insertion groove 301. In detail, the retaining element 330 includes two retaining bars 331 and a base plate 333 connected between the two retaining bars 331. The retaining bars 331 are symmetrically arranged on opposite ends of the base plate 333 and are perpendicular to the base plate 333. In some embodiments, each of the retaining bars 331 includes a via hole 331a, a first retaining portion 3311, a second retaining portion 3312, and a third retaining portion 3313.

As shown in FIG. 2, the first retaining portion 3311 is located at an end of the retaining bar 331 and bent toward the insertion groove 301. In detail, the first retaining portion 3311 bends inwardly to extend between the corresponding one of the slot walls 301b and the second casing portion 320, such that the first retaining portion 3311 is sloped relative to the insertion groove 301. The second retaining portion 3312 bends inwardly from the via hole 331a to be located at a recess formed on the second casing portion 320. The third retaining portion 3313 bends outwardly from the retaining bar 331 to form an outwardly curved profile. In addition, the third retaining portion 3313 is configured to engage with the retaining holes 321 (see FIG. 5), thereby ensuring the fastening between the retaining element 330 and the second casing portion 320.

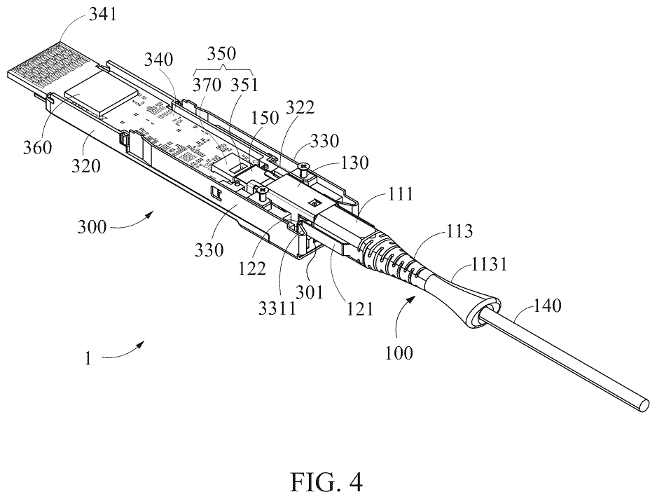

Referring to FIGS. 3 to 5, FIG. 3 is a schematic assembly view of the detachable optical cable 100 and the optical transceiver 300 to form an active optical cable 1, FIG. 4 is a perspective view of the active optical cable 1 of FIG. 3 in the absence of the first casing portion 310, and FIG. 5 is a schematic exploded view of the active optical cable 1. As shown in FIGS. 3 and 5, the detachable optical cable 100 is plugged into the optical transceiver 300 to form the active optical cable 1 or the optical transceiver 300 is plugged with the detachable optical cable 100. The boot portion 111 is plugged into the main groove portion 301a, and the two depressible arms 121 are located above the slot walls 301b, respectively.

As shown in FIG. 4, the depressible arms 121 snugly abuts the part of the retaining element 330 in the insertion groove 301. In detail, the fastening hook 122 is detachable fasten with the first retaining portion 3311, so the detachable optical cable 100 is securely retained in the optical transceiver 300 while the optical coupling device 150 is optically coupled with the waveguide device 350. In this embodiment, at least an optoelectronic integrated circuit 360 and the waveguide device 350 are mounted on the optoelectronic substrate 340. The waveguide device 350 is actively aligned with the optical coupling device 150 before the waveguide device 350 is fixed on the optoelectronic substrate 340 and used for coupling optical signals from or to the optical coupling device 150 after the optical coupling device 150 insert into the optical transceiver 300.

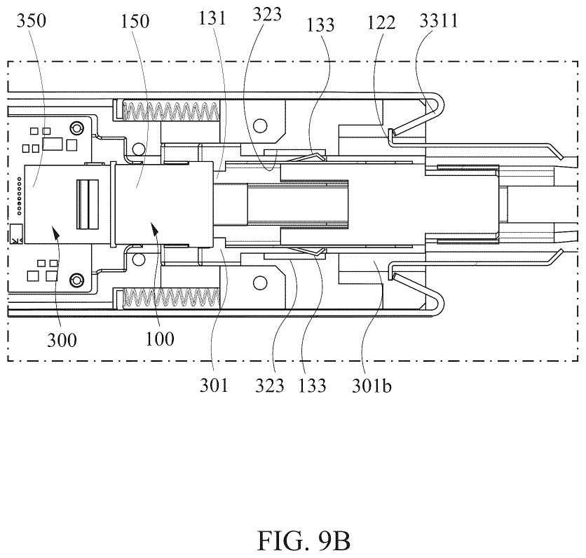

In some embodiments, as shown in FIG. 4, the waveguide device 350 is separately and detachably prepared from the optoelectronic substrate 340. In detail, the waveguide device 350 includes a waveguide base 370 and a waveguide substrate 351. The waveguide base 370 includes a recessed portion 373 exposed at a front end of the waveguide base 370 facing the detachable optical cable 100 (as shown in FIG. 9A, described later), and the waveguide substrate 351 is positioned in the recessed portion 373 in optical alignment with the detachable optical cable 100. What is more, the waveguide device 350 and the detachable optical cable 100 can be prepared separately from the optoelectronic substrate 340, which can improve the flexibility in fabrication of the active optical cable and is conducive to replacement of the components.

In some other embodiments, the waveguide substrate 351 may be part of the optoelectronic substrate 340 while the waveguide base 370 is disposed on the optoelectronic substrate 340. In detail, the optoelectronic substrate 340 is made of silicon, silicate, or silica and part of an edge of the optoelectronic substrate 340 convexly protrudes into the recessed portion 373 to form the waveguide substrate 351. The integral formation of the waveguide substrate 351 and the optoelectronic substrate 340 can simplify the fabrication process, thereby lowering the fabrication cost.

In some embodiments, the optoelectronic substrate 340 and/or the waveguide substrate 351 are a silicon-based substrate. Preferably, the waveguide substrate 351 is made of a material containing, for example, silica, and includes a plurality of light paths (not shown) for optical coupling with the optical coupling device 150. Alternatively, the waveguide substrate 351 may be made of a material containing silicon-on-insulator (SOI), lithium niobate (LiNbO₃), or polymers. In some embodiments, the waveguide substrate 351 may be formed using a material of such as fused silica, quartz, glass, borosilicate glass, etc. It should be noted that the waveguide substrate 351 includes a planar lightwave circuit (PLC). The planar lightwave circuit may be configured in various ways, including, but not limited to, a straight line circuit, a splitter circuit, an arrayed waveguide grating wavelength multiplexer, and a cross connect-type circuit. Different types of waveguide circuits or devices can be utilized for the planar lightwave circuit in the embodiments of the present application.

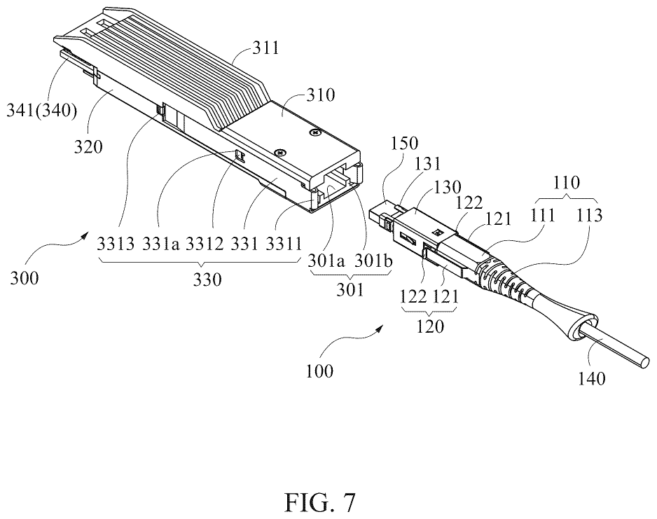

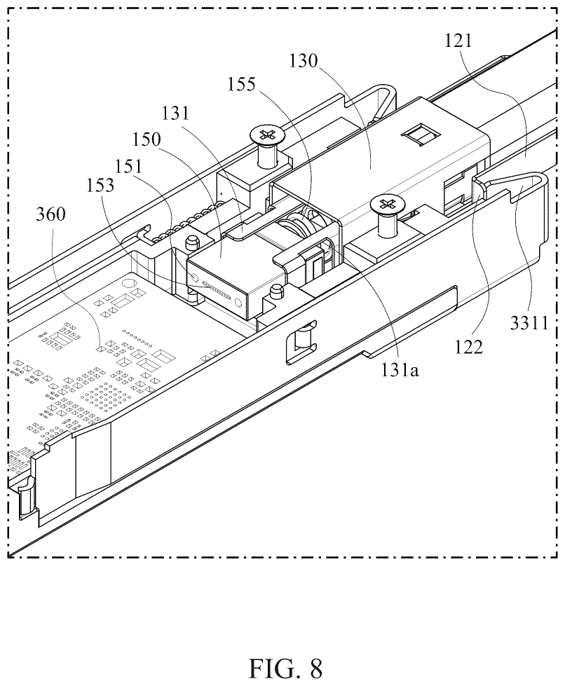

Referring to FIGS. 6 and 7 in combination with FIG. 3, when the detachable optical cable 100 is to be detached from the optical transceiver 300, users only need to press the depressible arms 121 of the depressible fastening member 120 and pull the boot element 110 out of the optical transceiver 300. When assembling, the detachable optical cable 100 only needs to be plugged into the optical transceiver 300 from the insertion groove 301, with or without pressing the depressible arms 121 till the fastening hooks 122 are engaged with the first retaining portions 3311 of the retaining element 330.

Referring to FIGS. 8 and 9A, FIG. 8 is a schematic perspective view of part of the active optical cable 1 in the absence of the first casing portion 310 and the waveguide device 350, and FIG. 9A is a schematic cross-sectional view of part of the active optical cable 1. The optical coupling device 150 includes a plurality of attaching portions 151 arranged on a front end of the optical coupling device 150 facing the waveguide device 350 and a plurality of alignment grooves 153 arranged between the attaching portions 151 (as shown in FIG. 8). The alignment grooves 153 may be V-like in shape and are configured to position a plurality of optical fibers of the optical fiber unit 140. As shown in FIG. 9A, the waveguide base 370 includes two positioning elements 371 arranged on the front end of the waveguide base 370 facing the optical coupling device 150, and the attaching portions 151 attach to the positioning elements 371, respectively, to position the alignment grooves 153 in optical alignment with the light paths of the waveguide substrate 351. In some embodiments, the positioning elements 371 are pin-like in shape and protrude frontward from the waveguide base 370, and the attaching portions 151 are groove-like in shape, so that the pin-like positioning elements 371 are insertable into the groove-like attaching portions 151. It should be noted that the attaching portions 151 and the positioning elements 371 are sized and shaped to enable mutual attachment for the purpose of securely positioning and connecting the optical coupling device 150 to the waveguide base 370, and their profiles are not limited thereto.

As shown in FIG. 9A, two buffer elements 322 are disposed between the retaining bars 331 and the second casing portion 320, respectively. The buffer elements 322 are provided to secure the retaining bars 331, thereby improving the assembly strength between the retaining element 330 and the casing unit 30. In detail, one end of each of the buffer elements 322 props against the second retaining portion 3312 of the retaining bar 331, and the other end props against the second casing portion 320. In some embodiments, the buffer elements 322 may be a resilient element such as a spring.

Still referring to FIGS. 8 and 9A, in some embodiments, a pushing element 155 is disposed in the housing structure 130, and one end of the pushing element 155 pushes the optical coupling device 150 against the holding elements 131 so that the optical coupling device 150 is tightly held between the holding elements 131. In some embodiments, the pushing element 155 may be a resilient element such as a spring.

Referring to FIG. 9B, which is a schematic cross-sectional view of part of the active optical cable 1, in some embodiments, the casing unit 30 forms two engaging grooves 323 located corresponding to the engaging elements 133. In detail, the engaging grooves 323 are recessed into the second casing portion 320 and adjoin the insertion hole 301. The engaging elements 133 are positioned in and abut against the engaging grooves 323, respectively. As shown in FIGS. 9A and 9B, the engagement between the engaging elements 133 and the engaging grooves 323 not only can further improve the fastening connection between the detachable optical cable 100 and the optical transceiver 300, but also can function to provide the position feedback for users to perceive that the optical coupling device 150 are being connected in position as soon as the engaging elements 133 are engaging with the engaging grooves 323.

Referring to FIG. 10, showing a plurality of active optical cables 1A detachably connected to a mating module 500, as shown in FIG. 10, the mating module 500 may be disposed in a switch (not shown) and configured to connect with four active optical cables 1A each consisting of the optical transceiver 300 and the detachable optical cable 100.

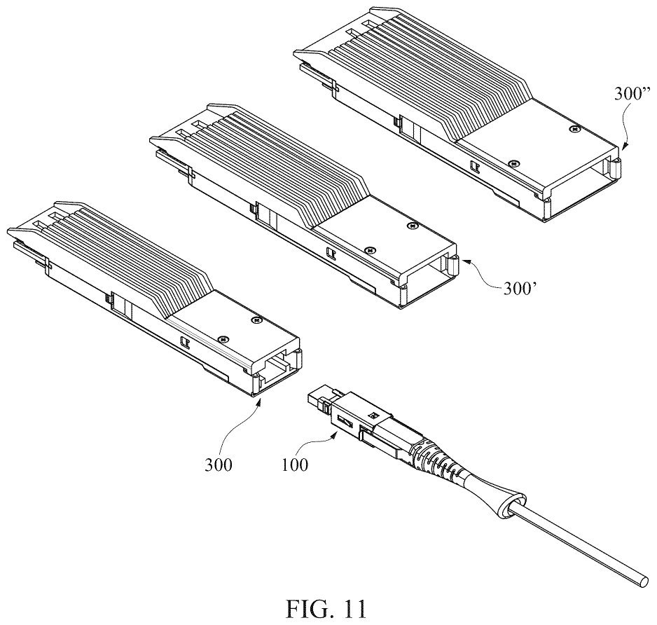

Referring to FIG. 11, the detachable optical cables 100 with different sizes is adaptable to various types of optical transceivers 300, 300′, 300″ provided in the present application. In some embodiments, the optical transceivers 300, 300′, 300″ may be 1.6 terabits per second, 1.6 T for short, 3.2 T, and 6.4 T optical transceivers, respectively, thereby achieving various applications for different capacity requirements.

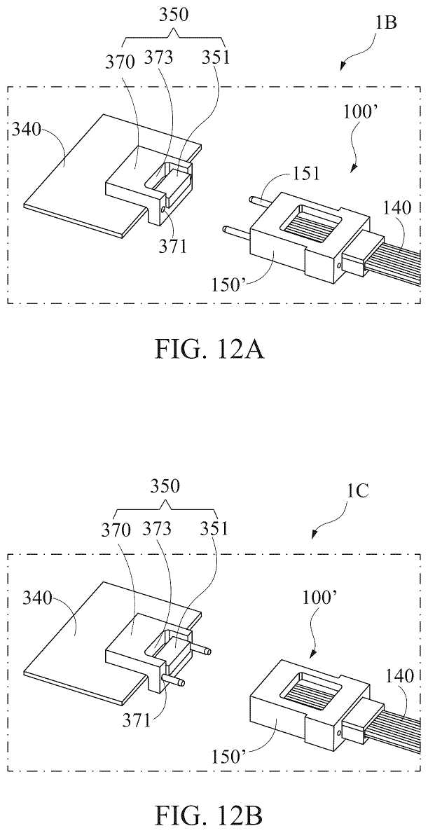

Referring to FIGS. 12A and 12B, which are partially perspective exploded views of an active optical cable in accordance with different embodiments, as shown in FIG. 12A, a waveguide base 370 is disposed on the optoelectronic substrate 340, and the waveguide device 350 is assembled with the waveguide base 370. In this embodiment, the waveguide base 370 includes a plurality of positioning elements 371, which are hole-like in shape and arranged on opposite sides of the waveguide base 370.

Referring to FIG. 12A, which is a partially perspective exploded view of an active optical cable 1B in accordance with an embodiment of the present application, in this embodiment, the active optical cable 1B includes a detachable optical cable 100′ including an optical fiber unit 140 and an optical coupling device 150′. The boot element 110, the depressible fastening member 120, and the housing structure 130 as described in the above embodiments are not shown for clarity. It should be noted that the casing unit 30 and the optoelectronic substrate 340 are not shown in FIG. 12A for clarity, either. In other words, the active optical cable 1B is simplified in structure. In detail, the detachable optical cable 100′ includes an optical coupling device 150′, which includes a plurality of attaching portions 151 that are pine-like in shape and are insertable to the positioning elements 371 of the waveguide base 370 of the waveguide device 350, so that the detachable optical cable 100′ is detachably connected to the waveguide base 370, thereby enabling optical signal transmission between the waveguide device 350 and the optical fiber unit 140.

As shown in FIG. 12B, which is a partially perspective exploded view of an active optical cable 1C in accordance with an embodiment of the present application, in this embodiment, the waveguide base 370 includes a plurality of pin-shaped positioning elements 371 arranged on opposite sides of the waveguide base 370, the optical coupling device 150′ includes a plurality of groove-shaped attaching portions (not shown for clarity) arranged to correspond to the pin-shaped positioning elements 371, which allows insertion of the pin-shaped positioning elements 371, thereby enabling a snug fit between the attaching portions and the positioning elements 371 and achieving optical signal transmission between the waveguide device 350 and the optical fiber unit 140.

Accordingly, the detachable optical cable 100 can be individually prepared from the optical transceiver 300 that is conducive to improving assembly efficiency by reducing time of reworking in comparison with an unseparated structure of active optical cable or by reducing time of trouble shooting in comparison with an optical transceiver without an adapted cable assembled, as well as simplifying the maintenance or replacement of internal components of the optical cable.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the embodiments described may be made without departing from the scope of the application.

What is claimed is:

1. An active optical cable, comprising:
a detachable optical cable comprising:
an optical fiber unit;
a boot element disposed around an end portion of the optical fiber unit;
a housing structure attached to an end of the boot element and comprising at least a holding element; and
an optical coupling device positioned at the holding element, wherein the end portion of the optical fiber unit extends to the optical coupling device; and
an optical transceiver detachably connected to the detachable optical cable, wherein the optical transceiver comprises:
a casing unit defining an insertion groove for insertion of the detachable optical cable;
an optoelectronic substrate disposed in the casing unit and configured for electrical-to-optical signal conversion and optical-to-electrical signal conversion; and
a waveguide device disposed on the optoelectronic substrate, wherein the optical coupling device is detachably positioned in optical alignment with the waveguide device for light signal transmission between the waveguide device and the optical fiber unit.

2. The active optical cable of claim 1, wherein the housing structure further comprises at least an engaging element protruding from the housing structure toward the casing unit, and the engaging element abuts against an inner wall of the casing unit in the insertion groove.

3. The active optical cable of claim 2, wherein the casing unit defines at least an engaging groove located corresponding to the engaging element, and the engaging element is positioned in and abuts against the engaging groove.

4. The active optical cable of claim 1, wherein two holding elements are spaced apart from each other, and the optical coupling device is clamped between the two holding elements.

5. The active optical cable of claim 4, wherein the optical coupling device comprises a plurality of attaching portions, the waveguide device comprises a waveguide base and a plurality of positioning elements arranged on a front end of the waveguide base facing the optical coupling device, and the attaching portions attach to the positioning elements, respectively.

6. The active optical cable of claim 5, wherein a pushing element is disposed in the housing structure, and one end of the pushing element pushes the optical coupling device against the holding elements such that the optical coupling device is tightly held between the holding elements.

7. The active optical cable of claim 5, wherein the waveguide device further comprises a waveguide substrate, the waveguide base comprises a recessed portion exposed at the front end of the waveguide base, and the waveguide substrate is positioned in the recessed portion in optical alignment with the optical coupling device.

8. The active optical cable of claim 1, wherein the detachable optical cable further comprises at least a depressible fastening member fixed to the boot element, and the optical transceiver further comprises a retaining element mounted to the casing unit, and wherein part of the retaining element is located in the insertion groove, and the depressible fastening member snugly abuts the part of the retaining element.

9. The active optical cable of claim 8, wherein the retaining element comprises two retaining bars and a base plate connected between the two retaining bars, the retaining bars are symmetrically arranged on opposite ends of the base plate and perpendicular to the base plate, and each of the retaining bars comprises a first retaining portion bent toward the insertion groove, and wherein the depressible fastening member comprises two depressible arms fixed to opposite sides of the boot element, and each of the depressible arms includes a fastening hook, which is fastenable with the first retaining portion.

10. The active optical cable of claim 8, wherein each of the retaining bars further comprises a second retaining portion protruding toward the insertion groove, and two buffer elements are disposed between the retaining bars and the casing unit, respectively, and wherein one end of each of the buffer elements props against the second retaining portion.

11. The active optical cable of claim 9, wherein the insertion groove comprises a main groove portion and two slot walls located at opposite sides of the main groove portion, and the depressible arms are located above the slot walls, respectively.

12. An optical transceiver, adapted to connect to a detachable optical cable, and the optical transceiver comprising:
a casing unit comprising a first casing portion and a second casing portion jointly defining an insertion groove for insertion of the detachable optical cable;
an optoelectronic substrate disposed on the second casing portion and configured for electrical-to-optical signal conversion and optical-to-electrical signal conversion;
a waveguide device detachably disposed on the optoelectronic substrate and comprising a waveguide base and a waveguide substrate positioned in the waveguide base; and
a retaining element mounted to the casing unit, wherein part of the retaining element is located in the insertion groove for retaining the detachable optical cable, such that a light signal output from the detachable optical cable is transmittable to the waveguide substrate.

13. The optical transceiver of claim 12, wherein the waveguide base comprises a recessed portion exposed at a front end of the waveguide base facing the detachable optical cable, and the waveguide substrate is positioned in the recessed portion configured for optical alignment with the detachable optical cable.

14. The optical transceiver of claim 12, wherein the retaining element comprises two retaining bars and a base plate connected between the two retaining bars, the retaining bars are symmetrically arranged on opposite ends of the base plate and perpendicular to the base plate, and each of the retaining bars comprises a first retaining portion bent toward the insertion groove.

15. The optical transceiver of claim 14, wherein each of the retaining bars further comprises a second retaining portion protruding toward the insertion groove, and two buffer elements are disposed between the retaining bars and the second casing portion, respectively, wherein one end of each of the buffer elements props against the second retaining portion.

16. An active optical cable, comprising:
a detachable optical cable comprising:
an optical fiber unit; and
an optical coupling device attached to an end of the optical fiber unit; and
an optical transceiver detachably connected to the detachable optical cable, wherein the optical transceiver comprises:
a casing unit defining an insertion groove for insertion of the detachable optical cable;
an optoelectronic substrate disposed in the casing unit and configured for electrical-to-optical signal conversion and optical-to-electrical signal conversion; and
a waveguide device comprising a waveguide base and a waveguide substrate positioned in the waveguide base, wherein the waveguide base is disposed on the optoelectronic substrate, and wherein the optical coupling device is detachably positioned in optical alignment with the waveguide substrate for light signal transmission between the waveguide substrate and the optical fiber unit.

17. The active optical cable of claim 16, wherein the waveguide base comprises a recessed portion exposed at a front end of the waveguide base, and the waveguide substrate is positioned in the recessed portion of the waveguide base.

18. The active optical cable of claim 16, wherein the waveguide base comprises a recessed portion exposed at a front end of the waveguide base, part of an edge of the optoelectronic substrate convexly protrudes into the recessed portion to define the waveguide substrate.

19. The active optical cable of claim 16, wherein the waveguide base comprises a plurality of positioning elements, the optical coupling device comprises a plurality of attaching portions, and the attaching portions attach to the positioning elements, respectively.
